(19) United States
(12) Patent Application Publication
(10) Pub. No.: US 2022/0410196 A1
(43) Pub. Date: Dec. 29, 2022

(54) METHOD FOR CONTROLLING SPRAYING DEVICE AND SPRAYING DEVICE

(71) Applicant: Panasonic Intellectual Property Management Co., Ltd., Osaka (JP)

(72) Inventors: NAOYA OKUBO, Osaka (JP); DAISUKE TABATA, Osaka (JP); HIDEYUKI TACHIKA, Osaka (JP)

(21) Appl. No.: 17/805,455

(22) Filed: Jun. 4, 2022

(30) Foreign Application Priority Data
Jun. 28, 2021 (JP) 2021-106913

(51) Int. Cl. B05B 12/04; B05B 12/00; B05B 12/12; G03B 21/608

(52) U.S. Cl. CPC B05B 12/04; B05B 12/004; B05B 12/12; G03B 21/608

(57) ABSTRACT

A mist spraying unit atomizes a liquid and sprays the liquid as a mist, a light projector irradiates a space into which the mist is sprayed from the mist spraying unit with light, an imaging unit images scattered light by the mist of the light irradiated from the light projector, and an arithmetic unit calculates a mist concentration in the space based on a luminance value of a pixel constituting an image acquired from the imaging unit, thereby stopping spraying of the mist sprayed from the mist spraying unit.

### BACKGROUND

### 1. Technical Field

The present disclosure relates to a method for controlling a spraying device and a spraying device that stop mist spraying with good reproducibility by irradiating a space in which mist is sprayed from a mist spraying unit with light from a light projector, acquiring scattered light as an image, and determining a mist concentration in the space based on a luminance value of a pixel constituting the image.

### 2. Description of the Related Art

By spraying a mist in which liquid is atomized into a space and scattering images or videos in the mist and the space, it is possible to create a space that is fantastic and comfortable. In addition, the presentation using the mist has high affinity with a human body or nature, and the usability thereof has been expanded in recent years.

However, since the mist floating in the space is easily affected by disturbance such as temperature and humidity or wind, and it is difficult to stably generate the mist or to control the diffusion, there is a problem that intended presentation cannot be realized when the mist is used for presentation. Therefore, it is expected that the mist concentration in the presentation space can be quantified and controlled.

For example, in response to the fact that the mist concentration used for the presentation is not stable and the intended presentation is not realized, a projection device that controls the mist concentration to fall within a predetermined range by measuring the mist concentration is disclosed (see, for example, Patent Literature 1). The projection device is configured such that a two-fluid nozzle, a projection device-side gas flow path, a projection device-side liquid flow path, a liquid pressure regulator, a gas valve, a liquid valve, a gas supply source, a liquid supply source, and a mist concentration measuring unit spray a mist. The controller of the projection device controls opening and closing of the gas valve and the liquid valve based on the image or video projected from the projector onto the screen to start and stop spraying of the mist, receives a mist concentration signal from the mist concentration measuring unit, and controls opening and closing of the gas valve and the liquid valve based on the received signal to start and stop spraying of the mist so that the mist concentration falls within a predetermined range. By using this projection device, it is possible to control the concentration of the mist in the indoor space.

### CITATION LIST

### Patent Literature

PTL 1: Unexamined Japanese Patent Publication No. 2020-173382

### SUMMARY

A method for controlling a spraying device according to one aspect of the present disclosure, includes:

starting, by a mist spraying unit, spraying of a mist;

irradiating, by a light projector, a space into which the mist is sprayed from the mist spraying unit with light;

generating, by an imaging unit, an image including a plurality of pixels by imaging scattered light of the light irradiated from the light projector, the scattered light being caused by the mist sprayed from the mist spraying unit;

acquiring, by an arithmetic unit, the image from the imaging unit and quantifying a plurality of luminance values each of which corresponds to one of the plurality of pixels;

calculating, by the arithmetic unit, an average luminance value of the image from the plurality of luminance values;

calculating, by the arithmetic unit, a change amount of the average luminance value at least based on the average luminance value;

calculating, by the arithmetic unit, an absolute value of the change amount of the average luminance value;

determining, by the arithmetic unit, whether or not the absolute value of the change amount of the average luminance value satisfies a predetermined condition; and

outputting, by the arithmetic unit, a signal for stopping the spraying of the mist sprayed from the mist spraying unit to the mist spraying unit when it is determined that the absolute value of the change amount of the average luminance value satisfies the predetermined condition.

A spraying device according to one aspect of the present disclosure, includes:

a mist spraying unit that sprays a mist;

a light projector that irradiates a space into which the mist is sprayed from the mist spraying unit with light;

an imaging unit that generates an image including a plurality of pixels by imaging scattered light of the light irradiated from the light projector, the scattered light being caused by the mist sprayed from the mist spraying unit; and an arithmetic unit that acquires the image from the imaging unit and quantifies a plurality of luminance values each of which corresponds to one of the plurality of pixels, calculates an average luminance value of the image from luminance values of the plurality of pixels, calculates a change amount of the average luminance value at least based on the average luminance value, calculates an absolute value of the change amount of the average luminance value, determines whether or not the absolute value of the change amount of the average luminance value satisfies a predetermined condition, and outputs a signal for stopping spraying of the mist sprayed from the mist spraying unit to the mist spraying unit when it is determined that the absolute value of the change amount of the average luminance value satisfies the predetermined condition.

### BRIEF DESCRIPTION OF THE DRAWINGS

FIG. 1 is a configuration diagram of a spraying device according to a first exemplary embodiment of the present disclosure;

FIG. 2 is a configuration diagram of a mist spraying unit according to the first exemplary embodiment of the present disclosure;

FIG. 3 is a flowchart illustrating an example of analysis processing in an arithmetic unit according to the first exemplary embodiment of the present disclosure; and

FIG. 4 is a configuration diagram of the arithmetic unit according to the first exemplary embodiment of the present disclosure.

### DETAILED DESCRIPTIONS

The projection device described in Patent Literature 1 receives a mist concentration signal from a mist concentration measuring unit, and controls opening and closing of a gas valve and a liquid valve based on the received signal to start and stop spraying of a mist so that the mist concentration falls within a predetermined range.

However, since this projection device irradiates a space into which a mist is sprayed with light from a light projector, and measures a mist concentration from the intensity of the scattered light detected by a light receiving unit, the projection device is easily affected by the local mist concentration, and the mist concentration cannot be accurately measured when the projection device has a spatially non-uniform distribution, and when the mist concentration is high, the mist concentration at which the spraying is stopped is not stable because the temporal change of the scattered light detected by the light receiving unit is small, and the reproducibility of presentation may be poor for use in entertainment or the like.

It is an object of the present disclosure to provide a method for controlling a spraying device and a spraying device capable of grasping a mist concentration in the entire space without being affected by a local change in mist concentration and stopping mist spraying with good reproducibility by irradiating a space into which a mist is sprayed with light from a light projector, acquiring scattered light as an image, and determining the mist concentration in the space based on a luminance value of a pixel constituting the image.

Hereinafter, an exemplary embodiment of the present disclosure will be described with reference to the drawings.

### First Exemplary Embodiment

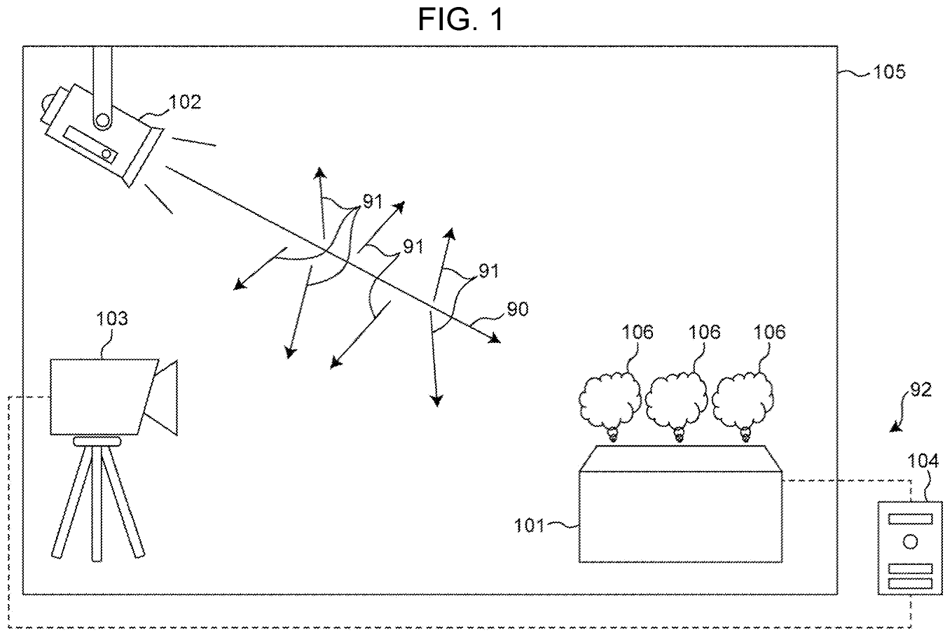

FIG. 1 is a view illustrating a configuration of spraying device 92 according to a first exemplary embodiment of the present disclosure.

In FIG. 1, spraying device 92 includes mist spraying unit 101 that starts and stops spraying of mist 106, light projector 102 that irradiates mist 106 with light, imaging unit 103 that acquires scattered light by mist 106 as an image, and arithmetic unit 104 that determines a mist concentration at which spraying of mist 106 is stopped.

Mist spraying unit 101 has a configuration necessary for spraying mist 106, such as supply and stop of liquid and gas and atomization means, and starts and stops spraying.

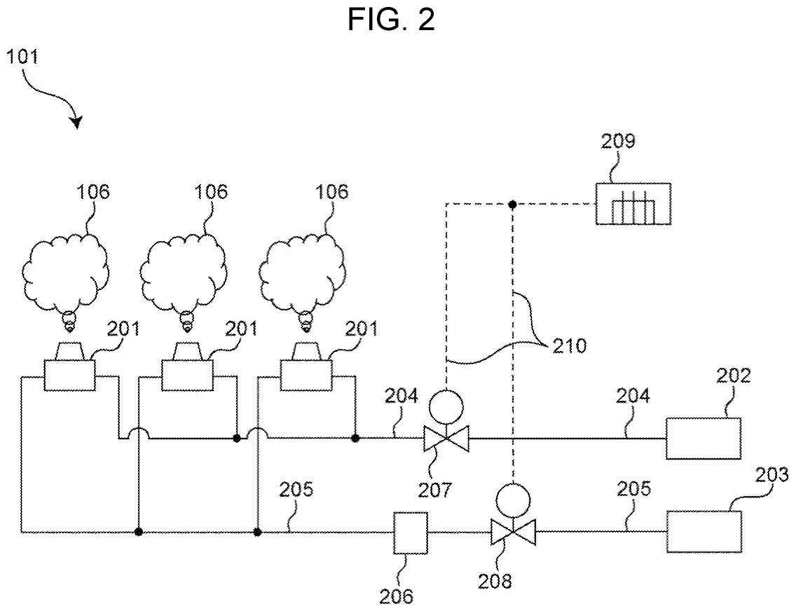

Mist spraying unit 101 of the first exemplary embodiment can be configured as shown in FIG. 2 as an example, but is not limited thereto.

In FIG. 2, mist spraying unit 101 includes a plurality of two-fluid nozzles 201, gas supply source 202, liquid supply source 203, gas flow path 204, liquid flow path 205, liquid pressure regulator 206, gas valve 207, liquid valve 208, controller 209, and control wiring 210, and constitutes a main part for spraying mist 106.

One gas supply source 202 supplies gas to each two-fluid nozzle 201 through gas flow path 204. An example of the gas is air.

One liquid supply source 203 supplies liquid to each two-fluid nozzle 201 through liquid flow path 205. An example of the liquid is water.

The liquid and the gas supplied to each two-fluid nozzle 201 are mixed in each two-fluid nozzle 201, and the liquid is atomized. Atomized mist 106 is sprayed from each two-fluid nozzle 201 into space 105.

As each two-fluid nozzle 201, an internal mixing type nozzle that supplies a compressed gas and a pressurized liquid to the nozzle, mixes the compressed gas and the pressurized liquid in the nozzle, and atomizes the liquid can be used.

As gas flow path 204 and liquid flow path 205, a metal pipe such as a steel pipe or a stainless steel pipe, a resin tube, or the like can be used.

Liquid pressure regulator 206 is disposed in liquid flow path 205 and can set the pressure of the liquid supplied to each two-fluid nozzle 201. As liquid pressure regulator 206, a regulator or a needle valve can be used, and a sprayed amount of mist 106 sprayed from each two-fluid nozzle 201 can be set.

As gas supply source 202, for example, a compressor, a blower, a pump, or the like that can supply compressed gas having a pressure of 0.1 MPa to 1.0 MPa can be used, and it is preferable that gas can be supplied to gas flow path 204 at a predetermined pressure via a regulator, a needle valve, or the like.

As liquid supply source 203, for example, a pump capable of supplying liquid at a pressure of 0.1 MPa to 1.0 MPa can be used, and it is preferable that liquid can be supplied to liquid flow path 205 at a predetermined pressure via a regulator, a needle valve, or the like. As liquid supply source 203, a pressurized tank that can supply liquid by pressurizing the liquid in a pressure container at a predetermined pressure using compressed gas may be used.

Gas valve 207 is installed in gas flow path 204 between two-fluid nozzle 201 on gas flow path 204 and closest to gas supply source 202 and gas supply source 202. Gas valve 207 is connected to controller 209 by control wiring 210, opens and closes with energization and non-energization from controller 209, and starts and stops supply of gas from gas supply source 202 to each two-fluid nozzle 201 via gas flow path 204.

Liquid valve 208 is installed in liquid flow path 205 between two-fluid nozzle 201 on liquid flow path 205 and closest to liquid supply source 203 and liquid supply source 203. Liquid valve 208 is connected to controller 209 by control wiring 210, opens and closes with energization and non-energization from controller 209, and starts and stops supply of liquid from liquid supply source 203 to each two-fluid nozzle 201 via liquid flow path 205.

As gas valve 207 and liquid valve 208, a two-way electromagnetic valve can be used, and a normally closed valve in which the valve is closed at the time of non-energization and the valve is opened at the time of energization is desirable.

Spraying of each two-fluid nozzle 201 is started when gas valve 207 is opened to supply gas to each two-fluid nozzle 201, and then liquid valve 208 is opened. The spraying of each two-fluid nozzle 201 is stopped when liquid valve 208 is closed, and then gas valve 207 is closed.

Controller 209 starts and stops spraying of mist 106 by outputting signals to gas valve 207 and liquid valve 208 to perform opening and closing control. For example, controller 209 controls opening and closing of gas valve 207 and liquid valve 208 to start and stop spraying of mist 106 at a spray start time or a spray stop time set in advance. As another example, controller 209 receives a signal for stopping spraying of mist 106 from arithmetic unit 104, and controls opening and closing of gas valve 207 and liquid valve 208 based on the received signal to stop spraying of mist 106, thereby controlling the mist concentration.

Mist 106 sprayed from mist spraying unit 101 desirably has a Sauter average particle diameter of about 5 μm to 10 μm from the viewpoint of a low sedimentation rate due to gravity and floating in the space for a long time, and from the viewpoint of having no wetting feeling and a small discomfort feeling even when touching the human skin.

The Sauter average particle diameter refers to a particle diameter having the same surface area to volume ratio as the total volume of all particles with respect to the total surface area of all particles. When there are nᵢ particles having a diameter dᵢ, the Sauter mean particle diameter (often denoted as D₃₂) is given by the following formula.

D₃₂=Σnᵢdᵢ³/Σnᵢdᵢ²

As light projector 102, an LED lamp, a high intensity discharge (HID) lamp, a fluorescent lamp, or the like can be used.

As an example, red light having a wavelength of about 640 nm to 780 nm can be used as light 90 irradiated from light projector 102. When light 90 hits a mist sufficiently smaller than the wavelength, scattered light 91 is affected by the wavelength, causing Rayleigh scattering. In Rayleigh scattering, the intensity of scattered light increases as the wavelength is shorter, and decreases as the wavelength is longer. In addition, when light 90 hits a mist sufficiently larger than the wavelength, Mie scattering occurs in which light of all wavelengths is scattered similarly without wavelength dependency. Since mist 106 sprayed from mist spraying unit 101 into space 105 has a wide distribution from a nano-order mist to a micro-order mist, both Rayleigh scattering and Mie scattering occur in space 105.

When the wavelength of light is short, the intensity of scattered light is high even in a state where the mist concentration is low, and in a case where the mist concentration becomes high, it is difficult for imaging unit 103 to grasp a fine change in the mist concentration. When the wavelength of light is long, even if the mist concentration is high, the scattered light intensity changes in accordance with the change in mist concentration, and the change in mist concentration can be accurately grasped by imaging unit 103.

Therefore, the mist concentration can be accurately determined by irradiating light having a long wavelength, for example, red light from light projector 102. Here, “accurately” means that responsiveness to change in mist concentration is improved by about 10% as compared with the case of using white light.

As an example, near-infrared light having a wavelength of about 780 nm to 2500 nm can be used as light 90 irradiated from light projector 102, and a near-infrared LED lamp or the like can be used as light projector 102.

Since near-infrared light cannot be detected by human eyes, the mist concentration can be determined without affecting the presentation.

Imaging unit 103 is disposed in space 105 in which mist 106 is sprayed, and when light projector 102 irradiates space 105 in which mist 106 is sprayed with light 90, the light is scattered by mist 106, and scattered light 91 is detected as an image. Since the intensity of scattered light 91 detected by imaging unit 103 depends on the mist concentration in space 105, the mist concentration can be determined by analyzing image data obtained by imaging unit 103 by arithmetic unit 104. Imaging unit 103 photographs space 105 at a plurality of different times to generate a plurality of images. Each image includes a plurality of pixels. Each pixel has a luminance value.

Analysis in arithmetic unit 104 performed on the image data obtained by imaging unit 103 will be described later.

As imaging unit 103, a CCD camera having, for example, a color filter and capable of detecting each of RGB wavelengths, a near-infrared camera, or the like can be used.

With regard to the positional relationship between imaging unit 103 and light projector 102, in the case of backlight, the influence of light irradiated from light projector 102 is large, and it is difficult to grasp the influence of diffusion of light due to mist. Therefore, it is desirable to arrange imaging unit 103 and light projector 102 so as to obtain follow light.

Arithmetic unit 104 outputs a signal for stopping spraying of mist 106 to mist spraying unit 101. Arithmetic unit 104 receives the image data from imaging unit 103, arithmetic unit 104 analyzes the image data received by arithmetic unit 104, arithmetic unit 104 determines the mist concentration, and arithmetic unit 104 outputs the spray stop signal to mist spraying unit 101 at the predetermined mist concentration.

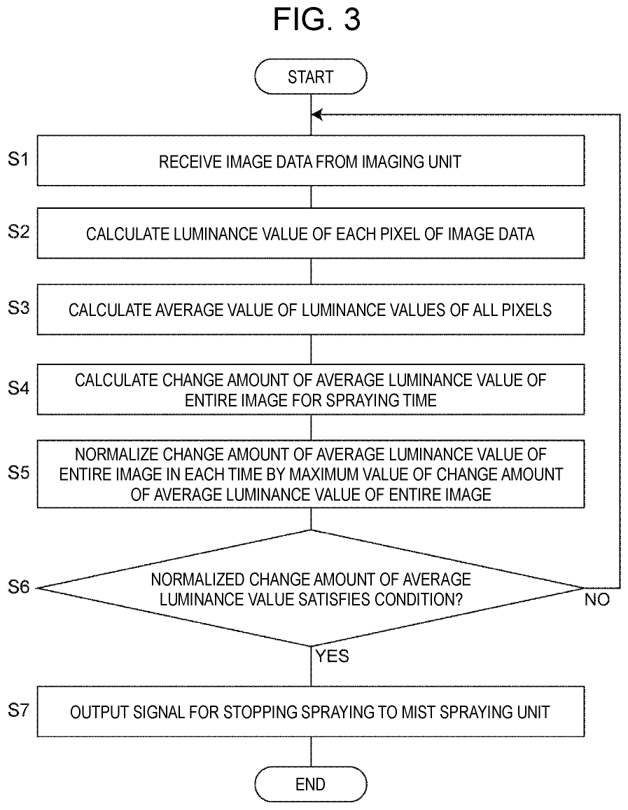

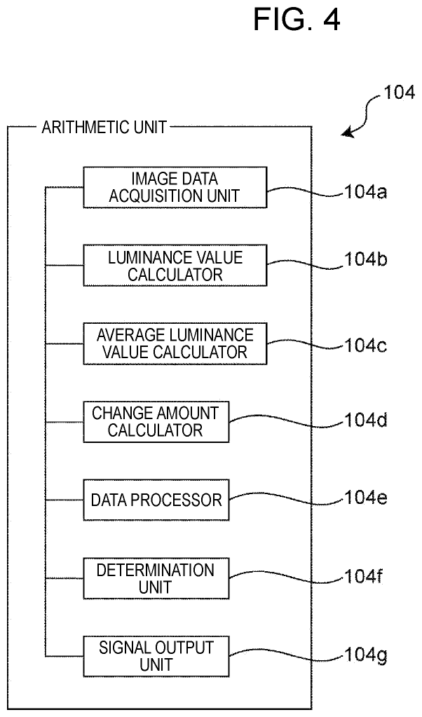

FIGS. 3 and 4 are a flowchart illustrating an example of analysis processing in arithmetic unit 104 and a configuration diagram of arithmetic unit 104, respectively.

Arithmetic unit 104 includes image data acquisition unit 104a, luminance value calculator 104b, average luminance value calculator 104c, change amount calculator 104d, data processor 104e, determination unit 104f, and signal output unit 104g.

First, in step S1, arithmetic unit 104 receives image data from imaging unit 103 by image data acquisition unit 104a.

Next, in step S2, arithmetic unit 104 calculates the luminance value of each pixel for each piece of image data obtained by imaging unit 103 in step S1 by luminance value calculator 104b.

Next, in step S3, arithmetic unit 104 causes average luminance value calculator 104c to calculate an average luminance value of the entire image from the luminance values of all the pixels calculated in step S2 and constituting one image.

Next, in step S4, arithmetic unit 104 causes change amount calculator 104d to calculate a slope of the average luminance value of the entire image with respect to a spray time based on the average luminance value of the entire image calculated in step S3, and causes the change amount calculator 104d to calculate the change amount of the average luminance value of the entire image in each time. In other words, arithmetic unit 104 calculates the change amount of a current average luminance value based on the average luminance value. For example, the change amount of the current average luminance value may be calculated by subtracting a past average luminance value from the current average luminance value.

Next, in step S5, arithmetic unit 104 causes data processor 104e to obtain the maximum value of the change amount of the average luminance value of the entire image calculated in step S4, and causes data processor 104e to normalize the change amount of the average luminance value of the entire image in each time from the maximum value.

Next, in step S6, arithmetic unit 104 causes determination unit 104f to determine whether or not the relationship between the spray time and the normalized change amount of the average luminance value of the entire image satisfies a preset condition. As an example, the preset condition is a condition that the spraying is stopped when the normalized change amount of the average luminance value of the entire image becomes “0.2 or less” after “1”. Determination unit 104f determines whether or not this condition is satisfied. When determination unit 104f determines that the condition is satisfied, the process proceeds to step S7, and if determination unit 104f determines that the condition is not satisfied, the predetermined mist concentration has not been reached, so that the process returns to step S1.

Next, in step S7, arithmetic unit 104 outputs a signal for stopping spraying to mist spraying unit 101 from signal output unit 104g.

Instead of obtaining and normalizing the maximum value of the change amount in step S5, data processor 104e may calculate the absolute value of the change amount in each time, and data processor 104e may compare the absolute values in step S6. If determination unit 104f determines that the predetermined condition is satisfied, the process may proceed to step S7. If determination unit 104f determines that the predetermined condition is not satisfied, the predetermined mist concentration has not been reached, and the process may return to step S1. Here, examples of the predetermined condition include a case where the absolute value is smaller than the previous data, a case where the absolute value is ½ or less of the previous data, and the like.

According to such a configuration, it is possible to stop the mist spraying at an arbitrary mist concentration with good reproducibility by irradiating space 105 where mist 106 is sprayed with light 90 from light projector 102 using mist spraying unit 101, acquiring scattered light 91 as an image, and determining the mist concentration in space 105 based on the luminance value of the pixel constituting the image.

In other words, it is possible to grasp the mist concentration of the entire space without being affected by a local change in the mist concentration, and to stop the mist spraying with good reproducibility by irradiating space 105 in which mist 106 is sprayed with light 90 from light projector 102, acquiring scattered light 91 as an image, and determining the mist concentration in space 105 based on the luminance value of the pixel constituting the image.

As a result, it is possible to achieve a great effect of improving the degree of freedom of spatial presentation and the value of video representation.

### Second Exemplary Embodiment

In a case where a visible light source such as an LED lamp or a fluorescent lamp is used for light projector 102, it is possible to obtain an effect similar to the effect in a case where red light is irradiated from light projector 102 and to accurately determine the mist concentration by extracting a component having a long wavelength of light, for example, a red component by arithmetic unit 104.

At this time, in step S2 of FIG. 3, arithmetic unit 104 extracts only the red component of the image data obtained from imaging unit 103.

In subsequent steps S3 to S7, similar processing is performed on the extracted red component data.

As an example of imaging unit 103, a CCD camera having, for example, a color filter and capable of detecting each of RGB wavelengths, or the like can be used.

According to such a configuration, it is possible to stop the mist spraying at an arbitrary mist concentration with good reproducibility by irradiating space 105 where mist 106 is sprayed with light 90 from light projector 102 using mist spraying unit 101, acquiring scattered light 91 as an image, and determining the mist concentration in space 105 based on the luminance value of the pixel constituting the image. As a result, it is possible to achieve a great effect of improving the degree of freedom of spatial presentation and the value of video representation.

When any exemplary embodiments or modifications are appropriately combined in the various exemplary embodiments or modifications described above, the effect possessed by each of them can be achieved. Additionally, the exemplary embodiments can be combined with each other, and the examples can be combined with each other, and then features in the different exemplary embodiments, or in the different examples, also can be combined with each other.

According to such a configuration, it is possible to stop the mist spraying at an arbitrary mist concentration with good reproducibility by irradiating space 105 where mist 106 is sprayed with light 90 from light projector 102 using mist spraying unit 101, acquiring scattered light 91 as an image, and determining the mist concentration in space 105 based on the luminance value of the pixel constituting the image. As a result, it is possible to achieve a great effect of improving the degree of freedom of spatial presentation and the value of video representation.

The method for controlling the spraying device and the spraying device according to the aspect of the present disclosure can stop the mist spraying at an arbitrary mist concentration with good reproducibility by irradiating a space in which the mist is sprayed from the mist spraying unit with light from the light projector, acquiring scattered light as an image, and determining the mist concentration in the space based on the luminance value of the pixel constituting the image. As a result, the above aspect of the present disclosure can improve the degree of freedom of spatial presentation and video representation, and is useful in the art or entertainment field.

What is claimed is:

1. A method for controlling a spraying device, the method comprising:
starting, by a mist spraying unit, spraying of a mist;
irradiating, by a light projector, a space into which the mist is sprayed from the mist spraying unit with light;
generating, by an imaging unit, an image including a plurality of pixels by imaging scattered light of the light irradiated from the light projector, the scattered light being caused by the mist sprayed from the mist spraying unit;
acquiring, by an arithmetic unit, the image from the imaging unit and quantifying a plurality of luminance values each of which corresponds to one of the plurality of pixels;
calculating, by the arithmetic unit, an average luminance value of the plurality of luminance values;
calculating, by the arithmetic unit, a change amount of the average luminance value at least based on the average luminance value;
calculating, by the arithmetic unit, an absolute value of the change amount of the average luminance value;
determining, by the arithmetic unit, whether or not the absolute value of the change amount of the average luminance value satisfies a predetermined condition; and
outputting, by the arithmetic unit, a signal for stopping the spraying of the mist sprayed from the mist spraying unit to the mist spraying unit when it is determined that the absolute value of the change amount of the average luminance value satisfies the predetermined condition.

2. The method for controlling the spraying device according to claim 1, the method further comprising:
instead of the calculating of the absolute value and the determining,
obtaining, by the arithmetic unit, a maximum value from among a plurality of change amounts in a plurality of times, the change amounts being the change amount;
calculating, by the arithmetic unit, a normalized change amount by normalizing the change amount of the average luminance value of the plurality of pixcels based on the maximum value; and
outputting, by the arithmetic unit, the signal for stopping spraying of the mist sprayed from the mist spraying unit to the mist spraying unit when the normalized change amount satisfies a predetermined condition.

3. The method for controlling the spraying device according to claim 1, the method further comprising detecting, by the imaging unit, each of RGB wavelengths and extracting, by the arithmetic unit, a red component.

4. The method for controlling the spraying device according to claim 1, wherein the light includes red light.

5. The method for controlling a spraying device according to claim 1, wherein the light includes near infrared light.

6. A spraying device comprising:
a mist spraying unit that sprays a mist;
a light projector that irradiates a space into which the mist is sprayed from the mist spraying unit with light;
an imaging unit that generates an image including a plurality of pixels by imaging scattered light of the light irradiated from the light projector, the scattered light being caused by the mist sprayed from the mist spraying unit; and
an arithmetic unit that
acquires the image from the imaging unit,
quantifies a plurality of luminance values each of which corresponds to one of the plurality of pixels,
calculates an average luminance value of the image from the plurality of luminance values,
calculates a change amount of the average luminance value at least based on the average luminance value,
calculates an absolute value of the change amount of the average luminance value,
determines whether or not the absolute value of the change amount of the average luminance value satisfies a predetermined condition, and
outputs a signal for stopping spraying of the mist sprayed from the mist spraying unit to the mist spraying unit when it is determined that the absolute value of the change amount of the average luminance value satisfies the predetermined condition.
